(19) United States
(12) Patent Application Publication
(10) Pub. No.: US 2009/0115815 A1
(43) Pub. Date: May 7, 2009

(54) METHOD FOR FILLING FUNCTIONAL LIQUID DROPLET EJECTION HEAD WITH FUNCTIONAL LIQUID, FUNCTIONAL LIQUID SUPPLYING DEVICE AND LIQUID DROPLET EJECTION APPARATUS FOR MANUFACTURING ELECTRO-OPTICAL APPARATUS, AND ELECTRO-OPTICAL APPARATUS

(75) Inventors: Tomohiko UDA, Shonai (JP); Yutaka WATANABE, Sakata (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/260,157

(22) Filed: Oct. 29, 2008

(30) Foreign Application Priority Data
Nov. 1, 2007 (JP) 2007-285391

(51) Int. Cl. B41J 2/165

(52) U.S. Cl. 347/28

(57) ABSTRACT

Provided herein is a method for filling a functional liquid droplet ejection head with functional liquid. The method includes: initially filling functional liquid channels and intrahead channels included in the functional liquid droplet ejection head with a functional liquid by introducing functional liquid from a functional liquid tank through the functional liquid channels to the functional liquid droplet ejection head used in an inkjet mode; and passing cleaning liquid into the functional liquid channels and the intrahead channel included in the functional liquid droplet ejection head prior to the initially filling.

The entire disclosure of Japanese Patent Application No. 2007-285391, filed on Nov. 1, 2007, is expressly incorporated by reference herein.

### BACKGROUND

1. Technical Field

The present invention relates to a method for filling a functional liquid droplet ejection head with functional liquid to fill with functional liquid functional liquid channels extending from a functional liquid tank to the functional liquid droplet ejection head and intrahead channels included in the functional liquid droplet ejection head, a functional liquid supplying device and liquid droplet ejection apparatus, a method for manufacturing an electro-optical apparatus, and an electro-optical apparatus.

2. Related Art

As such an ink filling method (functional liquid filling method), a method of ink filling by filling intrahead channels included in an inkjet head with a surfactant solution or an ink solution free from coloring agents for preservative solution beforehand and sucking the solution with ink from the nozzle side of the ink jet head, as described in JP-A-2004-114647, has been known in recent years. Such a filling method allows replacing preservative solution with ink after increasing wettability by reducing the surface tension of the preservative solution with a surfactant and filling the intrahead channels included in the inkjet head completely with the preservative solution.

Such an ink filling method that has been used makes it possible to fill the intrahead channels included in an inkjet head with ink without leaving bubbles; however, it involves a problem that bubbles remain in ink channels extending from an ink tank to the inkjet head, which has not been filled with preservative solution. A surfactant that has been kept as preservative solution in the intrahead channels for a long time may also precipitate impurities, resulting in clogging. Preservative solution also tends to remain in a narrow part of the intrahead channels; and it may not be replaced with ink and may remain in the inkjet head in initial filling. As a result, a large amount of ink may be flushed as waste in initial filling, or preservative solution may react with ink constituents to produce byproducts with passage of time.

### SUMMARY

An advantage of some aspects of the invention is to provide a method for filling a functional liquid droplet ejection head with functional liquid to allows for initial functional liquid filling of functional liquid channels extending from a functional liquid tank to the functional liquid droplet ejection head and intrahead channels included in the functional liquid droplet ejection head without leaving bubbles, a functional liquid supply device and liquid droplet ejection apparatus, a method for manufacturing an electro-optical apparatus, and an electro-optical apparatus.

A method for filling a functional liquid droplet ejection head with functional liquid according to an aspect of the invention includes: initially filling functional liquid channels and intrahead channels included in the functional liquid droplet ejection head with a functional liquid by introducing functional liquid from a functional liquid tank through the functional liquid channels to the functional liquid droplet ejection head used in an inkjet mode; and passing cleaning liquid into the functional liquid channels and the intrahead channels included in the functional liquid droplet ejection head prior to the initially filling.

A functional liquid supplying device according to another aspect of the invention includes: a functional liquid tank that supplies functional liquid to a functional liquid droplet ejection head used in an inkjet mode; cleaning liquid tanks that supply cleaning liquid to the functional liquid droplet ejection head; functional liquid channels that connect the functional liquid tank and the cleaning liquid tanks with the functional liquid droplet ejection head; a channel switching unit that makes the functional liquid channels fluidicly switch to be connected to the functional liquid tank or the cleaning liquid tanks at their upstream end; a suction unit that sucks up the functional liquid and the cleaning liquid individually, closely and detachably attached to a nozzle face of the functional liquid droplet ejection head; and a control unit that controls the channel switching unit and the suction unit. The control unit performs a cleaning liquid passage operation of making the functional liquid channels switch to be connected to the cleaning liquid tanks and driving the suction unit to pass cleaning liquid into the functional liquid channels and the intrahead channels included in the functional liquid droplet ejection head prior to an initial filling operation of making the functional liquid channels switch to be connected to the functional liquid tank and driving the suction unit to fill the functional liquid channels and the intrahead channels included in the functional liquid droplet ejection head with functional liquid.

With this configuration, the cleaning liquid cleans the functional liquid channels and the intrahead channels included in the functional liquid droplet ejection head before filling them with functional liquid. The cleaning liquid can not only wash foreign matter from the inside of the channels but wash off bubbles that tend to remain at corners or any other part of a coupling, remaining as a film on the inside of the channels. In the following functional liquid filling, therefore, functional liquid replaces cleaning liquid as if functional liquid washes cleaning liquid away, which prevents bubbles from remaining in the functional liquid channels and the intrahead channels in the initial-filling condition. This allows effectively preventing faulty ejections by the functional liquid droplet ejection head that are caused by bubbles.

In this situation, it is preferable that the solvent of the functional liquid be used as a cleaning liquid or that a solution containing a surfactant be used as a cleaning liquid in the passing cleaning liquid.

In this situation, it is also preferable that the cleaning liquid be any one of solutions containing the solvent of the functional liquid and a surfactant.

With this configuration, the affinity the functional liquid channels and the intrahead channels included in the functional liquid droplet ejection head have for the functional liquid is strengthened, which allows effectively preventing bubbles from remaining. It is preferable that the surfactant be butyl diglycol acetate.

In this situation, it is preferable that a solution containing the solvent of the functional liquid and a surfactant be used as a cleaning liquid and that the solution be passed after the solvent is passed in the passing cleaning liquid.

In this situation, it is also preferable that the cleaning liquid be a solution containing the solvent of the functional liquid and a surfactant, that the cleaning liquid tanks be formed of a solvent tank storing the solvent and a solution tank storing the solution, and that the channel switching unit be configured so as to be capable of switching channels for each of the functional liquid tank, the solvent tank and the solution tank; and it is also preferable that the control unit, in a cleaning liquid passage operation, first perform a solvent passage operation of making the functional liquid channels switch to be connected to the solvent tank and driving the suction unit to pass the solvent into the functional liquid channels and the intrahead channels included in the functional liquid droplet ejection head and next perform a solution passage operation of making the functional liquid channels switch to be connected to the solution tank and driving the suction unit to pass the solvent into the functional liquid channels and the intrahead channels included in the functional liquid droplet ejection head.

With this configuration, it is possible to wash functional liquid used for an ejection test or any other test with the solvent from the intrahead channels smoothly and to strengthen using the solution the affinity the functional liquid channels and intrahead channels have for the functional liquid. This allows effectively preventing bubbles from remaining in the functional liquid channels and intrahead channels when initial functional liquid filling is performed.

In this situation, it is preferable that a solution containing the solvent of the functional liquid and a surfactant be used as a cleaning liquid, that the solution be passed after the solvent is passed, and that the solvent be passed again in the passing cleaning liquid.

In this situation, it is also preferable that the cleaning liquid be a solution containing the solvent of the functional liquid and a surfactant, that the cleaning liquid tanks be formed of a solvent tank storing the solvent and a solution tank storing the solution, and that the channel switching unit be configured so as to be capable of switching channels for each of the functional liquid tank, the solvent tank and the solution tank; and it is also preferable that the control unit, in a cleaning liquid passage operation, first perform a solvent passage operation of making the functional liquid channels switch to be connected to the solvent tank and driving the suction unit to pass the solvent into the functional liquid channels and the intrahead channels included in the functional liquid droplet ejection head, next perform a solution passage operation of making the functional liquid channels switch to be connected to the solution tank and driving the suction unit to pass the solvent into the functional liquid channels and the intrahead channels included in the functional liquid droplet ejection head, and again perform the solvent passage operation.

With this configuration, the solvent of the functional liquid is passed again into the functional liquid channels and intrahead channels with increased wettability, which makes it possible to wash the surfactant remaining in the channels away completely and to absolutely prevent the surfactant from mixing in the functional liquid.

In this situation, it is preferable that initial filling be performed through suction of functional liquid from ejection nozzles on the functional liquid droplet ejection head with the functional liquid channels connected to the functional liquid tank in the initially filling, and that liquid passage be performed through suction of cleaning liquid from the ejection nozzles on the functional liquid droplet ejection head with the functional liquid channels switched to be connected to cleaning liquid tanks from functional liquid tanks in the passing cleaning liquid.

With this configuration, it is possible to perform cleaning liquid passage by the same suction operation as used for initial functional liquid filling, which allows simplifying the device configuration.

A liquid droplet ejection apparatus according to yet another aspect of the invention includes the above functional liquid supplying device and a plotting device that ejects functional liquid droplets while moving the functional liquid droplet ejection head relatively to a workpiece.

With this configuration, it is possible to fill the functional liquid channels and intrahead channels with functional liquid for plotting on a workpiece after cleaning the inside thereof, which allows a series of operations to be performed by a single device, shortening operation time and downsizing the liquid droplets ejection device.

A method for manufacturing an electro-optical apparatus according to a further aspect of the invention features to provide film deposition of functional liquid droplets on a workpiece by using the above liquid droplet ejection apparatus.

An electro-optical apparatus according to a still further aspect of the invention features to have film deposition of functional liquid droplets provided by the above liquid droplet ejection apparatus on the workpiece.

With this configuration, it is possible to improve productivity of workpieces by manufacturing with a liquid droplet ejection apparatus whose functional liquid droplet ejection head allows for efficient function restoration and maintenance. Electro-optical apparatus (flat-panel displays: FPDs) include a color filter, liquid crystal display, organic electro-luminescence device (organic EL device), plasma display panel device (PDP device) and electron emitting device. The electron emitting device is a concept including a field emission display (FED) device and surface-conduction electron-emitter display (SED) device, so-called. Electron emitting devices also include devices including formation of metallization, lens, resists, light diffusers or the like.

### BRIEF DESCRIPTION OF THE DRAWINGS

FIG. 1 is a plan view of a liquid droplet ejection apparatus.

FIG. 2 is a side view of the liquid droplet ejection apparatus.

FIG. 3 is a perspective view of a functional liquid droplet ejection head.

FIG. 4 is a systematic diagram of the functional liquid supplying device.

FIG. 5 is a flowchart illustrating manufacturing steps of a color filter.

FIGS. 6A to 6E are cross sectional view of the color filter in a process sequence.

FIG. 7 is a sectional view of an essential part of a liquid crystal display apparatus employing the color filter of the invention.

FIG. 8 is a sectional view of an essential part of a liquid crystal display apparatus according to the second example employing the color filter of the invention.

FIG. 9 is an exploded perspective view of a liquid crystal display apparatus according to the third example employing the color filter of the invention.

FIG. 10 is a sectional view illustrating an essential part of a display area of an organic EL apparatus.

FIG. 11 is a flowchart illustrating manufacturing steps of the display apparatus as the organic EL display apparatus.

FIG. 12 is a process chart illustrating formation of an inorganic bank layer.

FIG. 13 is a process chart illustrating formation of the organic bank layer.

FIG. 14 is a process chart illustrating processes of forming a positive-hole injection/transport layer.

FIG. 15 is a process chart illustrating a state where the positive-hole injection/transport layer has been formed.

FIG. 16 is a process chart illustrating processes for forming a light-emitting layer having a blue color component.

FIG. 17 is a process chart illustrating a state where the light-emitting layer having a blue color component has been formed.

FIG. 18 is a process chart illustrating a state where light-emitting layers having three color components have been formed.

FIG. 19 is a process chart illustrating processes for forming a cathode.

FIG. 20 is a perspective view illustrating an essential part of a plasma display apparatus (PDP apparatus).

FIG. 21 is a sectional view illustrating an essential part of an electron emission display apparatus (FED apparatus).

FIG. 22A is a plan view illustrating an electron emission portion and the vicinity thereof of a display apparatus, and FIG. 22B is a plan view illustrating a method of forming the electron emission portion and the vicinity thereof.

### DESCRIPTION OF EXEMPLARY EMBODIMENTS

A liquid droplet ejection apparatus to which a functional liquid supplying device according to an aspect of the invention is applied and a method for filling a functional liquid droplet ejection head with functional liquid will be described hereinafter with reference to the accompanying drawings, wherein like numbers reference like elements. Such a liquid droplet ejection apparatus is incorporated in a production line of flat panel displays; for example, a functional liquid droplet ejection head to which functional liquid—a special ink or luminous resin liquid is introduced is used to form luminous elements that constitute pixels included in a color filter of a liquid crystal display or an organic EL device.

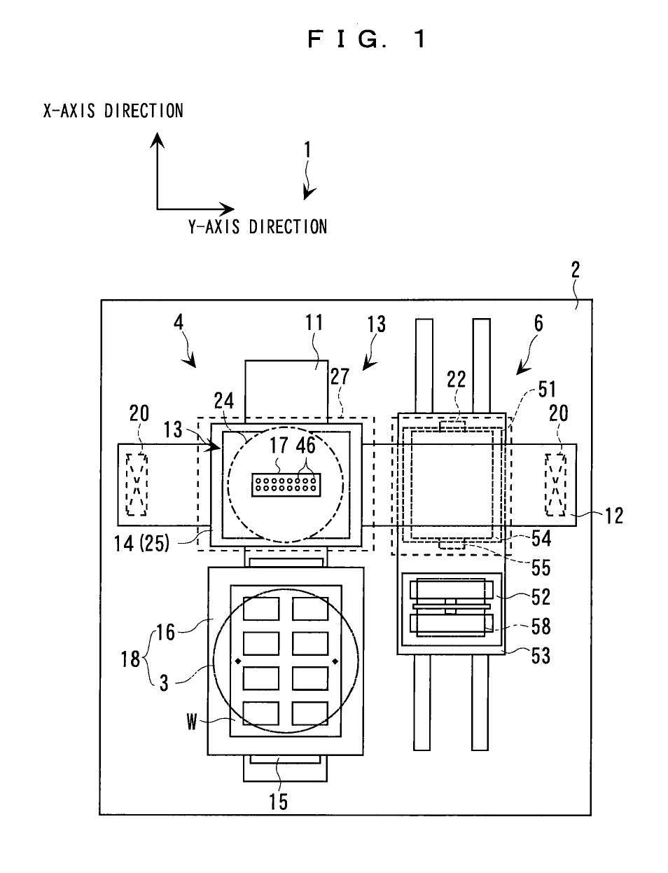

As shown in FIG. 1, a liquid droplet ejection apparatus 1 includes a machine frame 2, a plotting device 4 having a functional liquid droplet ejection head 17 and mounted in a cross shape on the machine frame 2, a functional liquid supplying device 5 that is connected to the plotting device 4, a maintenance device 6 that is mounted as an attachment to the plotting device 4 on the machine frame 2, and a control device 7 that controls those devices. Supplied with functional liquid by the functional liquid supplying device 5, the liquid droplet ejection apparatus 1 ejects supplied functional liquid based on control of the control device 7 to make a given plotting pattern on the workpiece W. The maintenance device 6 provides maintenance of the functional liquid droplet ejection head 17.

The plotting device 4 includes an X-and-Y-movement mechanism 13 that is formed of an X-axis table 11 giving a main scan (a movement in the X-axis direction) to the workpiece W and a Y-axis table 12 perpendicular to the X-axis table, a main carriage 13 that is movably mounted on the Y-axis table 12, and a head unit 14 that is mounted perpendicularly to the main carriage 13 and equipped with a plurality of functional liquid droplet ejection heads 17.

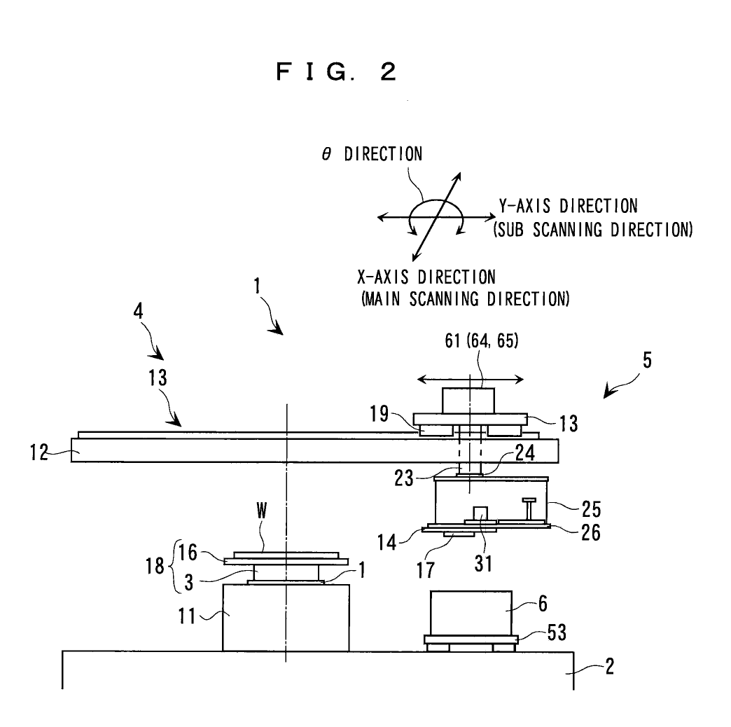

With a set table 21 formed of a suction table 16, θ table 3 and the like movably mounted thereon, the X-axis table 11 is configured to include an X-axis slider 15 that is driven by an X-axis motor (not shown) constituting a drive system in the X-axis direction. With the main carriage 13 supporting the head unit 14 mounted movably in the Y-axis direction thereon, the Y-axis table 12 is configured to include a Y-axis slider 19 that is driven by a Y-axis motor (not shown) constituting a drive system in the Y-axis direction. The X-axis table 11 is disposed in parallel in the X-axis direction, supported directly on the machine frame 2. Supported on right and left poles 20 that are erected on the machine frame 2, on the other hand, the Y-axis table 12 extends over the X-axis table 11 and maintenance device 6 in the Y-axis direction (see FIG. 1 and FIG. 2).

The liquid droplet ejection apparatus 1 has a plotting area 27—an area in which the X-axis table 11 and Y-axis table 12 overlap—for plotting on the workpiece W and a maintenance area 22—an area in which the Y-axis table 12 and maintenance device 6 overlap—for processes of functional restoration and maintenance of the functional liquid droplet ejection head 17 (maintenance); it has the head unit 14 face the plotting area 27 for plotting on the workpiece W; and it has the head unit 14 face the maintenance area 22 for maintenance.

As shown in FIG. 2, the main carriage 13 is formed of a suspension member 23 that is I-shaped in appearance and fixed on the bottom of the Y-axis slider 19 included in the Y-axis table 12, a θ-rotation mechanism 24 for compensating the position of the head unit 14 in the θ direction that is mounted on the bottom of the suspension member 23, and a carriage body (carriage) 25 that is mounted so as to be suspended under the θ-rotation mechanism 24. The carriage body 25 has a border frame (not shown) that includes an alignment mechanism, under which the head unit 14 is fixed in alignment with a support frame 26 to be described below therebetween. Each tank 61, 64 or 65 to be described below is disposed on the main carriage 13, connected through a tank-side tube 67 to the functional liquid droplet ejection head 17.

The support frame 26 is formed in a nearly-square border shape; and mounted in alignment thereon are the head unit 14 and a pressure control valve 31, in order from the bottom as shown in FIG. 2. The support frame 26 has a pair of handles (not shown). With the pair of handles used as a part to be held by hands, the support frame 26 may be attached to or removed from the main carriage 13.

As shown in FIG. 2, the head unit 14 includes the functional liquid droplet ejection head 17 and a head plate holding the functional liquid droplet ejection head 17 with a head support member (not shown) therebetween. The head plate is supported removably by the support frame 26. The head unit 14 is mounted in alignment under the carriage body 25 with the support frame 26 therebetween.

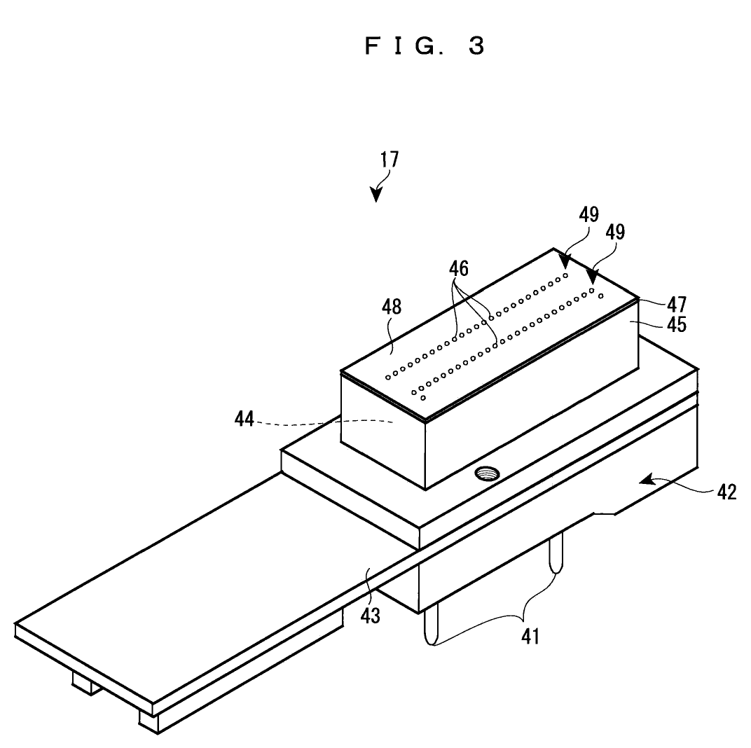

As shown in FIG. 3, the functional liquid droplet ejection head 17 is a so-called twin inkjet head, including a functional liquid introducer 42 that contains twin connecting needles 41 (functional liquid inlets), twin head substrates 43 that are mounted on the functional liquid introducer 42, and a head body 45 that is mounted on the bottom of the head substrates 43 and has intrahead channels 44 filled with functional liquid inside. The connecting needles 41 are connected to functional liquid supplying tubes 63 that are not shown in FIG. 3, supplying functional liquid to the head body 45 included in the functional liquid droplet ejection head 17. The head body 45 includes a nozzle plate 48 that has a nozzle face 47 with a plurality of ejection nozzles 46 open, pressure chambers (not shown) equipped with piezoelectric elements (not shown), diverging channels (not shown) connecting respective pressure chambers to respective ejection nozzles 46 as flow channels. Formed on the nozzle face 47 are nozzle lines 49 that has the multiple (one-hundred and eighty) ejection nozzles 46 connected to the respective diverging channels. This means that the intrahead channels 44 are formed of flow channels that extend from the connecting needles 41 (functional liquid inlets) through the pressure chambers and diverging channels to the ejection nozzles 46. Driven for ejection, the functional liquid droplet ejection head 17 ejects functional liquid droplets from the ejection nozzles 46 with the pressure chambers functioning as pumps.

The maintenance device 6 will be described hereinafter with reference to FIG. 1. The maintenance device 6 includes a preservation and suction unit 51 that seals the nozzle face of the functional liquid droplet ejection head 17 to prevent the ejection nozzles 46 from drying out and removes by suction thickened functional liquid from the ejection nozzles 46 of the functional liquid droplet ejection head 17 when the droplet ejection device 1 is out of operation; and it also includes a wiping unit 52 that wipes off blotches adherent to the nozzle face 47 of the functional liquid droplet ejection head 17. Mounted on a moving table 53 that is disposed so as to extend in the X-axis direction on the machine frame 2, both the units 51 and 52 are configured so as to be capable of being moved by the moving table 53 in the X-axis direction.

The preservation and suction unit 51 includes a sealing cap 54 that also functions as a flushing box to receive discharged ejection from the functional liquid droplet ejection head 17, a cap lifting mechanism 55 that lifts the sealing cap 54 up and down, a suction mechanism 56 that is formed of an ejector, suction pump and the like that sucks out of the functional liquid droplet ejection head 17 as connected to the sealing cap 54, and a waste liquid tank 57 that collects waste liquid removed by suction by the suction mechanism 56. When a plotting operation is stopped, the functional liquid droplet ejection head 17 moves to the maintenance area 22 on the moving table 53; and slightly apart from the functional liquid droplet ejection head 17, the sealing cap 54 receives flushing (discharged ejection) from the functional liquid droplet ejection head 17. When the functional liquid droplet ejection head 17 is on standby for operation, the sealing cap 54 lifts up thoroughly to perform capping of the nozzle face 47 of the functional liquid droplet ejection head 17, and seals all the ejection nozzles 46 of each functional liquid droplet ejection head 17. When the functional liquid droplet ejection head 17 that is being capped is driven again, the suction mechanism 56 is driven, if necessary, to suck thickened functional liquid out of the ejection nozzles 46 for prevention of nozzle clogging caused by thickened functional liquid. As described in detail below, the suction mechanism 56 and waste liquid tank 57 are also used for initial filling of the functional liquid droplet ejection head 17 with functional liquid.

As shown in FIG. 1, the wiping unit 52 is disposed so that wiping sheets 58 may reel in and out. The nozzle face 47 of the functional liquid droplet ejection head 17 is wiped off with the wiping sheets 58 reeling out and the wiping unit 52 kept in motion by the moving table 53 in the X-axis direction. Accordingly, the functional liquid adherent to the nozzle face of the functional liquid droplet ejection head 17 is removed through the suction and other operations described above, preventing deflection of ejected functional liquid droplets or other incidents. It is preferable that the maintenance device 6 include not only both the units 51 and 52 described above but an ejection inspection unit (not shown) that inspects the flight condition of functional liquid droplets ejected from the functional liquid droplet ejection head 17.

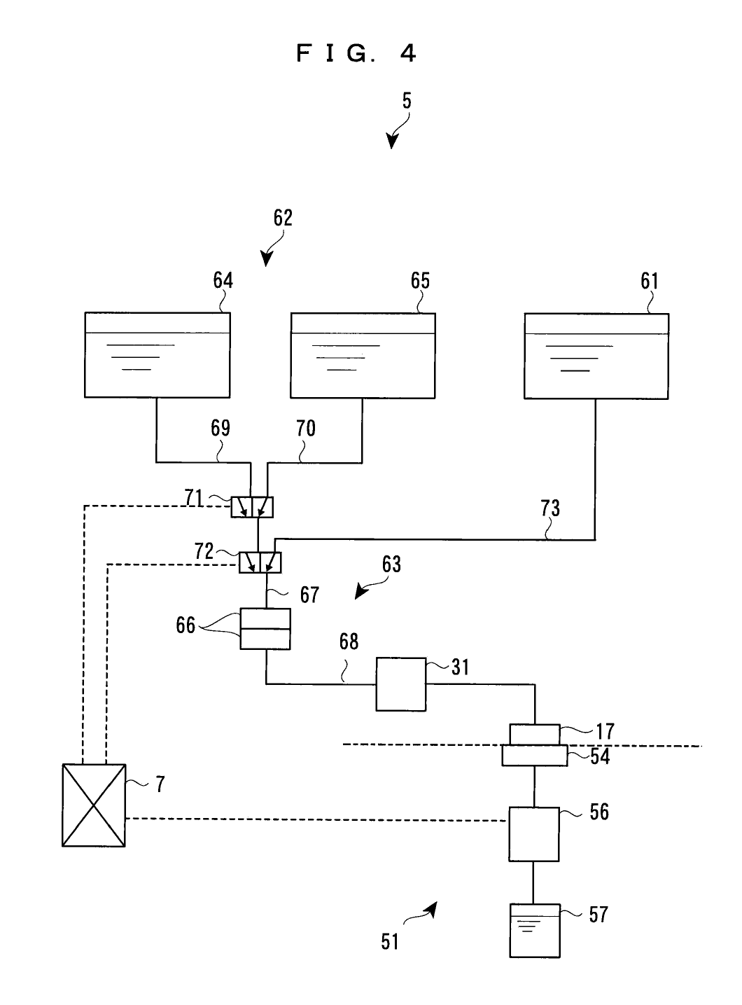

A configuration related to the functional liquid supplying device 5 will be described hereinafter with reference to a systematic diagram shown in FIG. 4. Supported by the support frame 26, the functional liquid supplying device 5 includes a functional liquid tank 61 that stores functional liquid, cleaning liquid tanks 62 that store cleaning liquid, functional liquid supplying tubes (functional liquid supplying channels) 63 that connect the functional liquid tank 61 and cleaning liquid tanks 62 with the functional liquid droplet ejection head 17, and a pressure control valve 31 that is provided at the middle of the functional liquid supplying tube 63. In this situation, the cleaning liquid tanks 62 are used for initial filling of the functional liquid droplet ejection head 17 with so-called functional liquid when the device is assembled or the head unit 14 is replaced; and they are formed of a solvent tank 64 that stores solvent of functional liquid serving as cleaning liquid, and a solution tank 65 that stores solution as cleaning solution including a surfactant. The functional liquid tank 61 may be a packaged tank or a subtank supplied with functional liquid from a main tank that is not shown in FIG. 4.

The functional liquid supplying tubes 63 include tank-side tubes 67 that lead from respective tanks 61, 64 and 65 to a coupling 66, and a head side tube 68 that leads from the coupling 66 through the pressure control valve 31 to the functional liquid droplet ejection head 17. The head-side tube 68 is incorporated in the head unit 14 and carried in with the head unit 14. On the other hand, all tanks 61, 64 or 65 and tank-side tubes 67 are mounted on the main carriage 13. The tank-side tubes 67 and head-side tube 68 may be separated by the coupling 66 (coupler providing a one-touch connection) when a replacement of the head unit 14 is made or any other event occurs.

The tank-side tubes 67 are formed of a solvent-tank-side short tube 69 that is connected to the solvent tank 64 at the upstream end, a solution-tank-side short tube 70 that is connected to the solution tank 65 at the upstream end, a main-tank-side tube 67 that leads from the downstream ends of both the tank-side short tubes 69 and 70 through a cleaning liquid switching valve 71 to the coupling 66, and a functional-liquid-tank-side short tube 73 that is connected to the functional liquid tank 61 at the upstream end and to the main-tank-side tube 67 at the downstream end through a switching valve 72. Connected to the downstream end of the main-tank-side tube 67 is the coupling 66 that provides a one-touch connection between the main-tank-side tube 67 and a head-side tube 68. A channel switching unit described in the appended claim is formed of a cleaning liquid switching valve 71 and switching valve 72.

With the pressure control valve 31 provided on the middle thereof, the head-side tube 68 is connected to the coupling 66 at the upstream end and to the functional liquid droplet ejection head 17 at the downstream end. As described in detail below, the position of each of the valves 71 and 72 is switched and the suction mechanism 56 (ejector or suction pump) included in the above preservation and suction unit 51 is driven, so that the liquid stored in each tank 61, 64 or 65 is passed into or used to fill the functional liquid droplet ejection head 17 via the functional liquid supplying tubes 63. The functional liquid supplying device described in the appended claim is a combination of a functional liquid supplying device 5 and preservation and suction unit 51 according to the embodiment.

The pressure control valve 31 is disposed close to the upstream end of the functional liquid droplet ejection head 17; and it includes a primary chamber that is connected to the functional liquid tank 61, solvent tank 64 and solution tank 65, a secondary chamber that is connected to the functional liquid droplet ejection head 17 and used to decompress the liquid, a communicating channel that has the primary and secondary chambers in communication, and a valve body that is disposed in the communicating channel, constituting a pressure reducing valve based on the atmospheric pressure, which is not specifically shown in FIG. 4. The pressure control valve 31 adjusts the head of the functional liquid at the nozzle face 47 of the functional liquid droplet ejection head 17 to an appropriate value even when the functional liquid tank 61 is in a high position. The primary and secondary chambers are decoupled by the valve body, which prevents pulsations occurring on the side of the functional liquid tank 61 from being carried to the functional liquid droplet ejection head 17 (damper function). Accordingly, as plotting on a workpiece W is performed, the hydraulic pressure of functional liquid carried to the pressure control valve 31 varies with passage of time; however, the functional liquid droplet ejection head 17 always ejects droplets under a constant pressure using the pressure control valve 31.

The main part of the control device 7 is formed of a central processing unit (CPU), read only memory (ROM), random access memory (RAM) and the like; and it switches the position of each of the valves 71 and 72 and drives the suction mechanism 56 for a plotting operation on a workpiece W, maintenance of the functional liquid droplet ejection head 17 and various types of operation described below to control a liquid passage operation and other operations.

A series of methods for filling the functional liquid droplet ejection head 17 with functional liquid by using the functional liquid supplying device 5 and preservation and suction unit 51 described above will be described hereinafter with reference to FIG. 4. When a replacement of the head unit 14 is made or any other operation therefor is performed, each of the tank-side tubes 67 that is above the coupling 66 (female end) has been filled with functional liquid or cleaning liquid. At this point, the functional liquid filling method is a method for filling with functional liquid the head-side tube 68 below the coupling 66 (male end) and the intrahead channel 44 included in the functional liquid droplet ejection head 17; and the functional liquid channels described in the appended claim is the head-side tube including the pressure control valve 31 below the coupling 66 and the intrahead channel 44. In this situation, performed as a functional liquid filling method are a cleaning operation of passing cleaning liquid and an initial filling operation of functional liquid filling; and a regular initial filling of the functional liquid droplet ejection head 17 by suction constitutes an operation of initial filling.

Performed as a cleaning operation are a first solvent passage operation of passing a solvent of functional liquid into the head-side tube 68 and intrahead channel 44 included in the functional liquid droplet ejection head 17, a solution passage operation of passing a solution including a solvent and surfactant into the channels, and a second solvent passage operation of passing a solvent of functional liquid into the channels again.

In the first solvent passage operation, firstly, the cleaning liquid switching valve 71 is switched to be connected to the solvent tank 64 and the switching valve 72 is switched to be connected to the cleaning liquid tank 62; secondly, the solvent tank 64 and functional liquid droplet ejection head 17 are into communication through the functional liquid supplying tube 63; and lastly, the suction mechanism 56 is driven. As a result, the solvent stored in the solvent tank 64 is passed through the solvent-tank-side short tube 69 and main-tank-side tube 67 into the head-side tube 68 including the pressure control valve 31 and the intrahead channel 44 included in the functional liquid droplet ejection head 17.

Similarly, in the solution passage operation, firstly, the cleaning liquid switching valve 71 is switched to be connected to the solution tank 65 and the switching valve 72 is switched to be connected to the cleaning liquid tank 62; secondly, the solution tank 65 and functional liquid droplet ejection head 17 are into communication through the functional liquid supplying tube 63; and lastly, the suction mechanism 56 is driven. As a result, the solution stored in the solution tank 65 is passed into the head-side tube 68 including the pressure control valve 31 and the intrahead channel 44 included in the functional liquid droplet ejection head 17.

In the second solvent passage operation, the cleaning liquid switching valve 71 is switched to be connected to the solvent tank 64 again and the switching valve 72 is switched to be connected to the cleaning liquid tank 62; the solvent tank 64 and functional liquid droplet ejection head 17 are into communication through the functional liquid supplying tube 63; and lastly, the suction mechanism 56 is driven. As a result, the solvent stored in the solvent tank 64 is passed into the head-side tube 68 including the pressure control valve 31 and the intrahead channel 44 included in the functional liquid droplet ejection head 17.

The completion of the above cleaning operations is followed by the initial filling operation. In the initial filling operation, the switching valve 72 is switched to be connected to the functional liquid tank 61; and the functional liquid tank 61 and functional liquid droplet ejection head 17 are into communication through the functional liquid supplying tube 63. With the suction mechanism 56 driven, the functional liquid stored in the functional liquid tank 61 is passed into the head-side tube 68 including the pressure control valve 31 and the intrahead channel 44 included in the functional liquid droplet ejection head 17. After the liquid passage is performed for a given time, the suction mechanism 56 is stopped to complete the initial filling. After the initial filling, the wiping of the functional liquid droplet ejection head 17 is performed to have the functional liquid droplet ejection head 17 on standby for plotting.

As described above, the solvent of functional liquid is passed into the head-side tube 68 and intrahead channel 44 included in the functional liquid droplet ejection head 17, which strengthens the affinity the head-side tube 68 and intrahead channel 44 have for the functional liquid; then, a solution containing a surfactant is passed, which allows the solution to spread all over in the channels and makes it possible to remove foreign matter; and the solvent of the functional liquid is passed again, which washes off a surfactant remaining in the channels and replaces the surfactant remaining in the channels with functional liquid. As a result, bubbles are not left even in an internal narrow part, such as a coupling 66 and pressure control valve 31, which allows filling the head-side tube 68 and functional liquid droplet ejection head 17 with functional liquid.

In the cleaning operation, it is also possible to pass the solvent of functional liquid or a solution only; and the order or number of cleaning operations is not limited.

Taking electro-optical apparatuses (flat panel display apparatuses) manufactured using the liquid droplet ejection apparatus 1 and active matrix substrates formed on the electro-optical apparatuses as display apparatuses as examples, configurations and manufacturing methods thereof will now be described. Examples of the electro-optical apparatuses include a color filter, a liquid crystal display apparatus, an organic EL apparatus, a plasma display apparatus (PDP (plasma display panel) apparatus), and an electron emission apparatus (FED (field emission display) apparatus and SED (surface-conduction electron emitter display) apparatus). Note that the active matrix substrate includes thin-film transistors, source lines and data lines which are electrically connected to the thin film transistors.

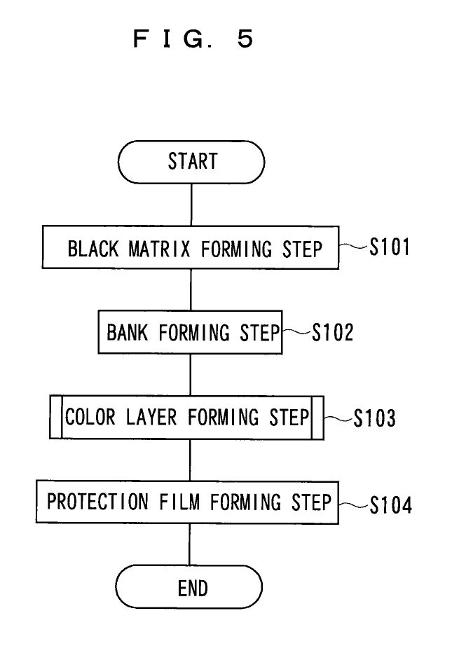

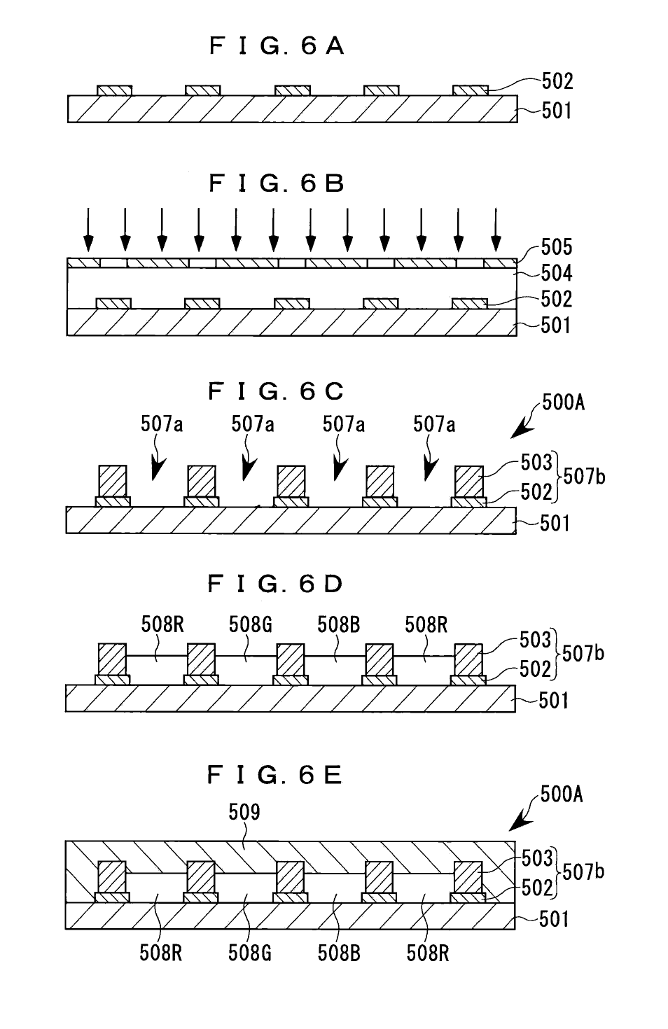

First, a manufacturing method of a color filter incorporated in a liquid crystal display apparatus or an organic EL apparatus will be described. FIG. 5 shows a flowchart illustrating manufacturing steps of a color filter. FIGS. 6A to 6E are sectional views of the color filter 500 (a filter substrate 500A) of this embodiment shown in an order of the manufacturing steps.

In a black matrix forming step (step S101), as shown in FIG. 6A, a black matrix 502 is formed on the substrate (W) 501. The black matrix 502 is formed of a chromium metal, a laminated body of a chromium metal and a chromium oxide, or a resin black, for example. The black matrix 502 may be formed of a thin metal film by a sputtering method or a vapor deposition method. Alternatively, the black matrix 502 may be formed of a thin resin film by a gravure plotting method, a photoresist method, or a thermal transfer method.

In a bank forming step (step S102), the bank 503 is formed so as to be superposed on the black matrix 502. Specifically, as shown in FIG. 6B, a resist layer 504 which is formed of a transparent negative photosensitive resin is formed so as to cover the substrate 501 and the black matrix 502. An upper surface of the resist layer 504 is covered with a mask film 505 formed in a matrix pattern. In this state, exposure processing is performed.

Furthermore, as shown in FIG. 6C, the resist layer 504 is patterned by performing etching processing on portions of the resist layer 504 which are not exposed, and the bank 503 is thus formed. Note that when the black matrix 502 is formed of a resin black, the black matrix 502 also serves as a bank.

The bank 503 and the black matrix 502 disposed beneath the bank 503 serve as a partition wall 507b for partitioning the pixel areas 507a. The partition wall 507b defines receiving areas for receiving the functional liquid ejected when the functional liquid droplet ejection heads 17 form coloring layers (film portions) 508R, 508G, and 508B in a subsequent coloring layer forming step.

The filter substrate 500A is obtained through the black matrix forming step and the bank forming step.

Note that, in this embodiment, a resin material having a lyophobic (hydrophobic) film surface is used as a material of the bank 503. Since a surface of the substrate (glass substrate) 501 is lyophilic (hydrophilic), variation of positions to which the liquid droplet is projected in the each of the pixel areas 507a surrounded by the bank 503 (partition wall 507b) can be automatically corrected in the subsequent coloring layer forming step.

In the coloring layer forming step (S103), as shown in FIG. 6D, the functional liquid droplet ejection heads 17 eject the functional liquid within the pixel areas 507a each of which are surrounded by the partition wall 507b. In this case, the functional liquid droplet ejection heads 17 eject functional liquid droplets using functional liquid (filter materials) of colors R, G, and B. A color scheme pattern of the three colors R, G, and B may be the stripe arrangement, the mosaic arrangement, or the delta arrangement.

Then drying processing (such as heat treatment) is performed so that the three color functional liquid are fixed, and thus three coloring layers 508R, 508G, and 508B are formed. Thereafter, a protective film forming step is reached (step S104). As shown in FIG. 6E, a protective film 509 is formed so as to cover surfaces of the substrate 501, the partition wall 507b, and the three coloring layers 508R, 508G, and 508B.

That is, after liquid used for the protective film is ejected onto the entire surface of the substrate 501 on which the coloring layers 508R, 508G, and 508B are formed and the drying process is performed, the protective film 509 is formed.

In the manufacturing method of the color filter 500, after the protective film 509 is formed, a coating step is performed in which ITO (Indium Tin Oxide) serving as a transparent electrode in the subsequent step is coated.

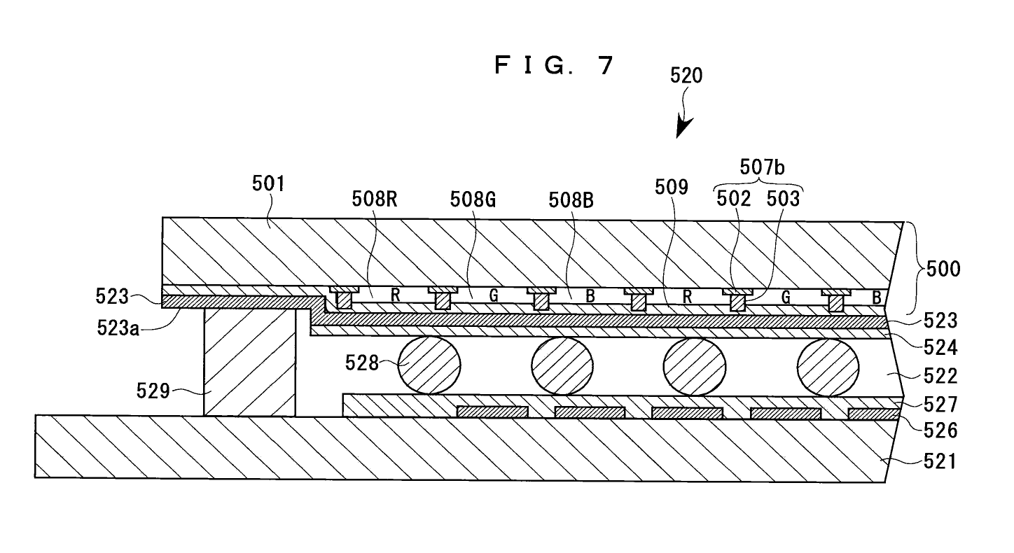

FIG. 7 is a sectional view of an essential part of a passive matrix liquid crystal display apparatus (liquid crystal display apparatus 520) and schematically illustrates a configuration thereof as an example of a liquid crystal display apparatus employing the color filter 500. A transmissive liquid crystal display apparatus as a final product can be obtained by disposing a liquid crystal driving IC (integrated circuit), a backlight, and additional components such as supporting members on the display apparatus 520. Note that the color filter 500 is the same as that shown in FIGS. 6A to 6E, and therefore, reference numerals the same as those used in FIGS. 6A to 6E to denote the same components, and descriptions thereof are omitted.

The display apparatus 520 includes the color filter 500, a counter substrate 521 such as a glass substrate, and a liquid crystal layer 522 formed of STN (super twisted nematic) liquid crystal compositions sandwiched therebetween. The color filter 500 is disposed on the upper side of FIG. 7 (on an observer side).

Although not shown, polarizing plates are disposed so as to face an outer surface of the counter substrate 521 and an outer surface of the color filter 500 (surfaces which are remote from the liquid crystal layer 522). A backlight is disposed so as to face an outer surface of the polarizing plate disposed near the counter substrate 521.

A plurality of rectangular first electrodes 523 extending in a horizontal direction in FIG. 7 are formed with predetermined intervals therebetween on a surface of the protective film 509 (near the liquid crystal layer 522) of the color filter 500. A first alignment layer 524 is arranged so as to cover surfaces of the first electrodes 523 which are surfaces remote from the color filter 500.

On the other hand, a plurality of rectangular second electrodes 526 extending in a direction perpendicular to the first electrodes 523 disposed on the color filter 500 are formed with predetermined intervals therebetween on a surface of the counter substrate 521 which faces the color filter 500. A second alignment layer 527 is arranged so as to cover surfaces of the second electrodes 526 near the liquid crystal layer 522. The first electrodes 523 and the second electrodes 526 are formed of a transparent conductive material such as an ITO.

A plurality of spacers 528 disposed in the liquid crystal layer 522 are used to maintain the thickness (cell gap) of the liquid crystal layer 522 constant. A seal member 529 is used to prevent the liquid crystal compositions in the liquid crystal layer 522 from leaking to the outside. Note that an end of each of the first electrodes 523 extends beyond the seal member 529 and serves as wiring 523a.

Pixels are arranged at intersections of the first electrodes 523 and the second electrodes 526. The coloring layers 508R, 508G, and 508B are arranged on the color filter 500 so as to correspond to the pixels.

In normal manufacturing processing, the first electrodes 523 are patterned and the first alignment layer 524 is applied on the color filter 500 whereby a first half portion of the display apparatus 520 on the color filter 500 side is manufactured. Similarly, the second electrodes 526 are patterned and the second alignment layer 527 is applied on the counter substrate 521 whereby a second half portion of the display apparatus 520 on the counter substrate 521 side is manufactured. Thereafter, the spacers 528 and the seal member 529 are formed on the second half portion, and the first half portion is attached to the second half portion. Then, liquid crystal to be included in the liquid crystal layer 522 is injected from an inlet of the seal member 529, and the inlet is sealed. Finally, the polarizing plates and the backlight are disposed.

The liquid droplet ejection apparatus 1 of this embodiment may apply a spacer material (functional liquid) constituting the cell gap, for example, and uniformly apply liquid crystal (functional liquid) to an area sealed by the seal member 529 before the first half portion is attached to the second half portion. Furthermore, the seal member 529 may be printed using the functional liquid droplet ejection heads 17. Moreover, the first alignment layer 524 and the second alignment layer 527 may be applied using the functional liquid droplet ejection heads 17.

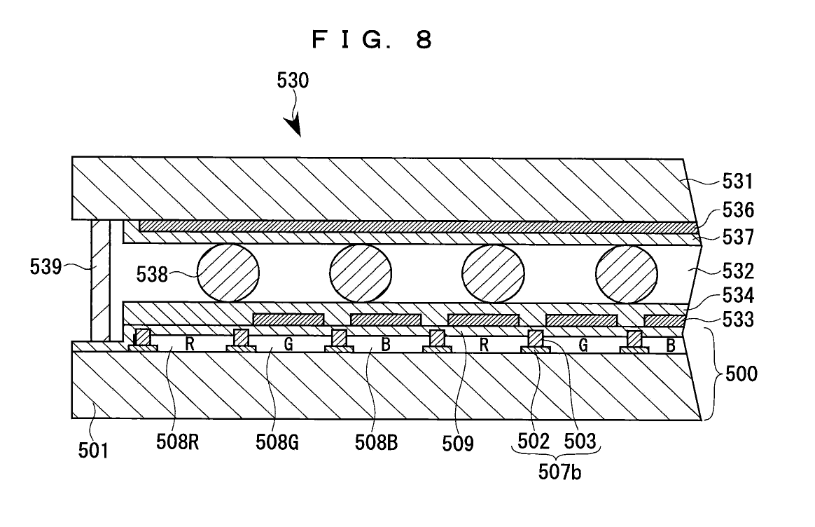

FIG. 8 is a sectional view of an essential part of a display apparatus 530 and schematically illustrates a configuration thereof as a second example of a liquid crystal display apparatus employing the color filter 500 which is manufactured in this embodiment.

The display apparatus 530 is considerably different from the display apparatus 520 in that the color filter 500 is disposed on a lower side in FIG. 8 (remote from the observer).

The display apparatus 530 is substantially configured such that a liquid crystal layer 532 constituted by STN liquid crystal is arranged between the color filter 500 and a counter substrate 531 such as a glass substrate. Although not shown, polarizing plates are disposed so as to face an outer surface of the counter substrate 531 and an outer surface of the color filter 500.

A plurality of rectangular first electrodes 533 extending in a depth direction of FIG. 8 are formed with predetermined intervals therebetween on a surface of the protective film 509 (near the liquid crystal layer 532) of the color filter 500. A first alignment layer 534 is arranged so as to cover surfaces of the first electrodes 533 which are surfaces near the liquid crystal layer 532.

On the other hand, a plurality of rectangular second electrodes 536 extending in a direction perpendicular to the first electrodes 533 disposed on the color filter 500 are formed with predetermined intervals therebetween on a surface of the counter substrate 531 which faces the color filter 500. A second alignment layer 537 is arranged so as to cover surfaces of the second electrodes 536 near the liquid crystal layer 532.

A plurality of spacers 538 disposed in the liquid crystal layer 532 are used to maintain the thickness (cell gap) of the liquid crystal layer 532 constant. A seal member 539 is used to prevent the liquid crystal compositions in the liquid crystal layer 532 from leaking to the outside.

As with the display apparatus 520, pixels are arranged at intersections of the first electrodes 533 and the second electrodes 536. The coloring layers 508R, 508G, and 508B are arranged on the color filter 500 so as to correspond to the pixels.

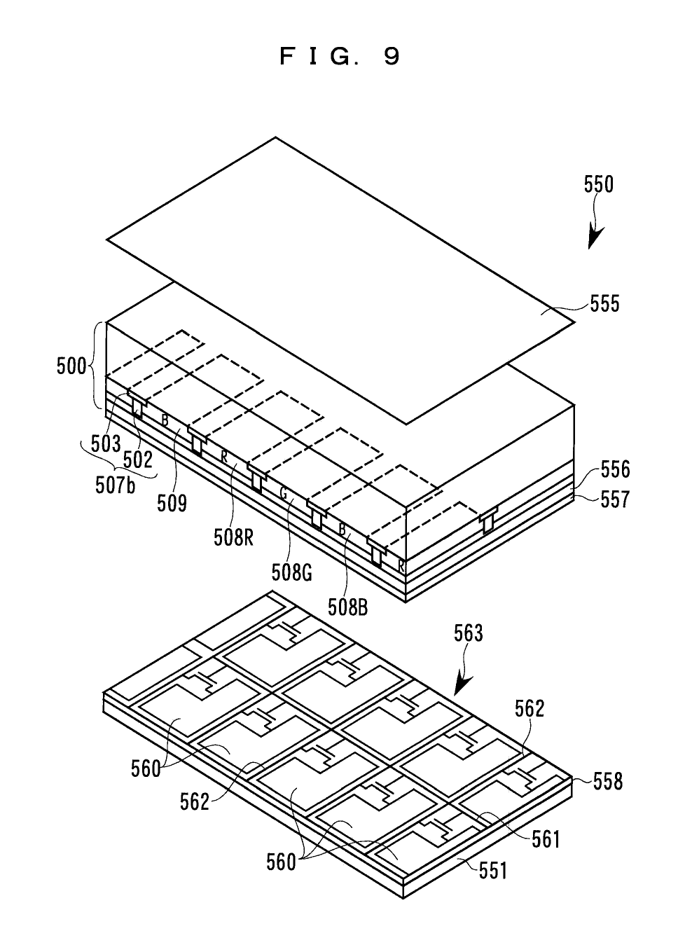

FIG. 9 is an exploded perspective view of a transmissive TFT (thin film transistor) liquid crystal display device and schematically illustrates a configuration thereof as a third example of a liquid crystal display apparatus employing the color filter 500 to which the invention is applied.

A liquid crystal display apparatus 550 has the color filter 500 disposed on the upper side of FIG. 9 (on the observer side).

The liquid crystal display apparatus 550 includes the color filter 500, a counter substrate 551 disposed so as to face the color filter 500, a liquid crystal layer (not shown) interposed therebetween, a polarizing plate 555 disposed so as to face an upper surface of the color filter 500 (on the observer side), and a polarizing plate (not shown) disposed so as to face a lower surface of the counter substrate 551.

An electrode 556 used for driving the liquid crystal is formed on a surface of the protective film 509 (a surface near the counter substrate 551) of the color filter 500. The electrode 556 is formed of a transparent conductive material such as an ITO and entirely covers an area in which pixel electrodes 560 are to be formed which will be described later. An alignment layer 557 is arranged so as to cover a surface of the electrode 556 remote from the pixel electrode 560.

An insulating film 558 is formed on a surface of the counter substrate 551 which faces the color filter 500. On the insulating film 558, scanning lines 561 and signal lines 562 are arranged so as to intersect with each other. Pixel electrodes 560 are formed in areas surrounded by the scanning lines 561 and the signal lines 562. Note that an alignment layer (not shown) is arranged on the pixel electrodes 560 in an actual liquid crystal display apparatus.

Thin-film transistors 563 each of which includes a source electrode, a drain electrode, a semiconductor layer, and a gate electrode are incorporated in areas surrounded by notch portions of the pixel electrodes 560, the scanning lines 561, and the signal lines 562. When signals are supplied to the scanning lines 561 and the signal lines 562, the thin-film transistors 563 are turned on or off so that power supply to the pixel electrodes 560 is controlled.

Note that although each of the display apparatuses 520, 530, and 550 is configured as a transmissive liquid crystal display apparatus, each of the display apparatuses 520, 530, and 550 may be configured as a reflective liquid crystal display apparatus having a reflective layer or a semi-transmissive liquid crystal display apparatus having a semi-transmissive reflective layer.

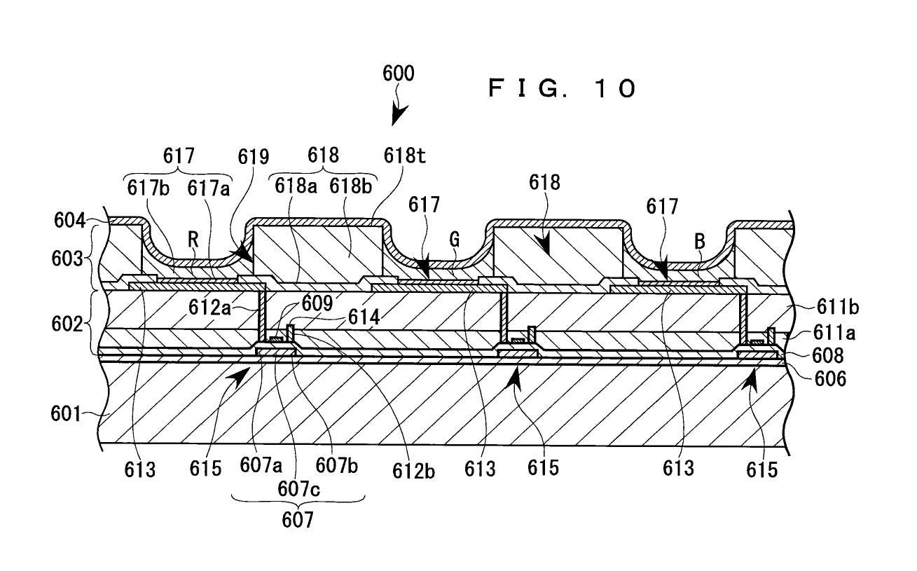

FIG. 10 is a sectional view illustrating an essential part of a display area of an organic EL apparatus (hereinafter simply referred to as a display apparatus 600).

In this display apparatus 600, a circuit element portion 602, a light-emitting element portion 603, and a cathode 604 are laminated on a substrate (W) 601.

In this display apparatus 600, light is emitted from the light-emitting element portion 603 through the circuit element portion 602 toward the substrate 601 and eventually is emitted to an observer side. In addition, light emitted from the light-emitting element portion 603 toward an opposite side of the substrate 601 is reflected by the cathode 604, and thereafter passes through the circuit element portion 602 and the substrate 601 to be emitted to the observer side.

An underlayer protective film 606 formed of a silicon oxide film is arranged between the circuit element portion 602 and the substrate 601. Semiconductor films 607 formed of polysilicon oxide films are formed on the underlayer protective film 606 (near the light-emitting element portion 603) in an isolated manner. In each of the semiconductor films 607, a source region 607a and a drain region 607b are formed on the left and right sides thereof, respectively, by high-concentration positive-ion implantation. The center portion of each of the semiconductor films 607 which is not subjected to high-concentration positive-ion implantation serves as a channel region 607c.

In the circuit element portion 602, the underlayer protective film 606 and a transparent gate insulating film 608 covering the semiconductor films 607 are formed. Gate electrodes 609 formed of, for example, Al, Mo, Ta, Ti, or W are disposed on the gate insulating film 608 so as to correspond to the channel regions 607c of the semiconductor films 607. A first transparent interlayer insulating film 611a and a second transparent interlayer insulating film 611b are formed on the gate electrodes 609 and the gate insulating film 608. Contact holes 612a and 612b are formed so as to penetrate the first interlayer insulating film 611a and the second interlayer insulating film 611b and to be connected to the source region 607a and the drain region 607b of the semiconductor films 607.

Pixel electrodes 613 which are formed of ITOs, for example, and which are patterned to have a predetermined shape are formed on the second interlayer insulating film 611b. The pixel electrode 613 is connected to the source region 607a through the contact holes 612a.

Power source lines 614 are arranged on the first interlayer insulating film 611a. The power source lines 614 are connected through the contact holes 612b to the drain region 607b.

Thus, the circuit element portion 602 includes thin-film transistors 615 connected to drive the respective pixel electrodes 613.

The light-emitting element portion 603 includes functional layers 617 each formed on a corresponding one of pixel electrodes 613, and bank portions 618 which are formed between the pixel electrodes 613 and the functional layers 617 and which are used to partition the functional layers 617 from one another.

The pixel electrodes 613, the functional layers 617, and the cathode 604 formed on the functional layers 617 constitute the light-emitting element. Note that the pixel electrodes 613 are formed into a substantially rectangular shape in plan view by patterning, and the bank portions 618 are formed so that each two of the pixel electrodes 613 sandwich a corresponding one of the bank portions 618.

Each of the bank portions 618 includes an inorganic bank layer 618a (first bank layer) formed of an inorganic material such as SiO, SiO₂, or TiO₂, and an organic bank layer 618b (second bank layer) which is formed on the inorganic bank layer 618a and has a trapezoidal shape in a sectional view. The organic bank layer 618b is formed of a resist, such as an acrylic resin or a polyimide resin, which has an excellent heat resistance and an excellent lyophobic characteristic. A part of each of the bank portions 618 overlaps peripheries of corresponding two of the pixel electrodes 613 which sandwich each of the bank portions 618.

Openings 619 are formed between the bank portions 618 so as to gradually increase in size upwardly against the pixel electrodes 613.

Each of the functional layers 617 includes a positive-hole injection/transport layer 617a formed so as to be laminated on the pixel electrodes 613 and a light-emitting layer 617b formed on the positive-hole injection/transport layer 617a. Note that another functional layer having another function may be arranged so as to be arranged adjacent to the light-emitting layer 617b. For example, an electronic transport layer may be formed.

The positive-hole injection/transport layer 617a transports positive holes from a corresponding one of the pixel electrodes 613 and injects the transported positive holes to the light-emitting layer 617b. The positive-hole injection/transport layer 617a is formed by ejection of a first composition (functional liquid) including a positive-hole injection/transport layer forming material. The positive-hole injection/transport layer forming material may be a known material.

The light-emitting layer 617b is used for emission of light having colors red (R), green (G), or blue (B), and is formed by ejection of a second composition (functional liquid) including a material for forming the light-emitting layer 617b (light-emitting material). As a solvent of the second composition (nonpolar solvent), a known material which is insoluble to the positive-hole injection/transport layer 617a is preferably used. Since such a nonpolar solvent is used as the second composition of the light-emitting layer 617b, the light-emitting layer 617b can be formed without dissolving the positive-hole injection/transport layer 617a again.

The light-emitting layer 617b is configured such that the positive holes injected from the positive-hole injection/transport layer 617a and electrons injected from the cathode 604 are recombined in the light-emitting layer 617b so as to emit light.

The cathode 604 is formed so as to cover an entire surface of the light-emitting element portion 603, and in combination with the pixel electrodes 613, supplies current to the functional layers 617. Note that a sealing member (not shown) is arranged on the cathode 604.

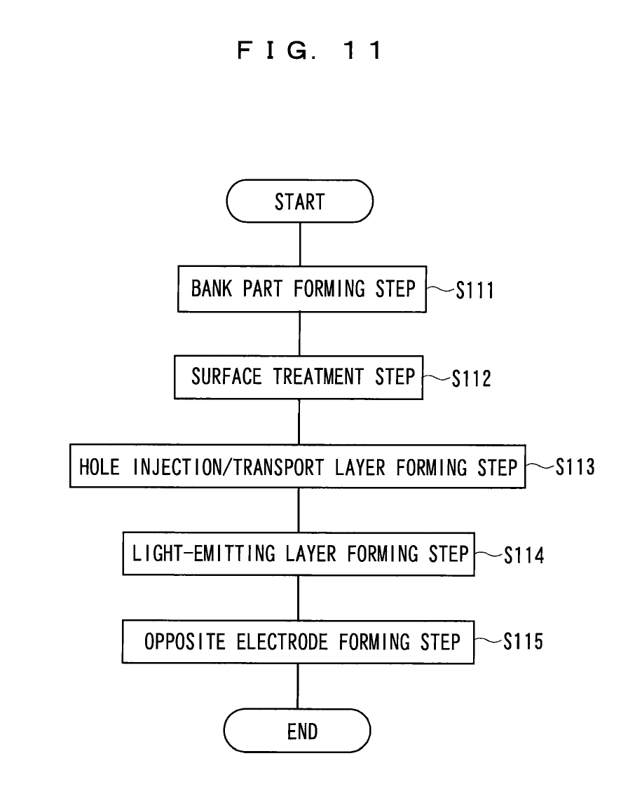

Steps of manufacturing the display apparatus 600 will now be described with reference to FIGS. 11 to 19.

As shown in FIG. 11, the display apparatus 600 is manufactured through a bank portion forming step (S111), a surface processing step (S112), a positive-hole injection/transport layer forming step (S113), a light-emitting layer forming step (S114), and a counter electrode forming step (S115). Note that the manufacturing steps are not limited to these examples shown in FIG. 11, and one of these steps may be omitted or another step may be added according as desired.

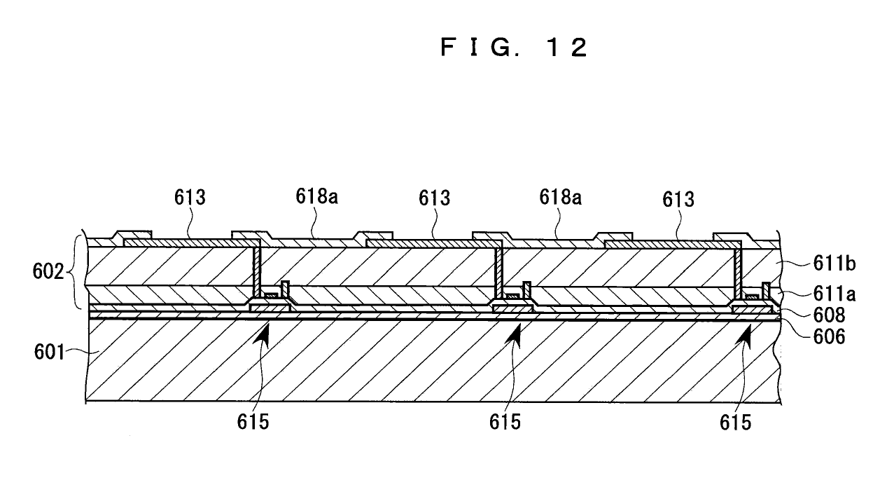

In the bank portion forming step (S111), as shown in FIG. 12, the inorganic bank layers 618a are formed on the second interlayer insulating film 611b. The inorganic bank layers 618a are formed by forming an inorganic film at a desired position and by patterning the inorganic film by the photolithography technique. At this time, a part of each of the inorganic bank layers 618a overlaps peripheries of corresponding two of the pixel electrodes 613 which sandwich each of the inorganic bank layers 618a.

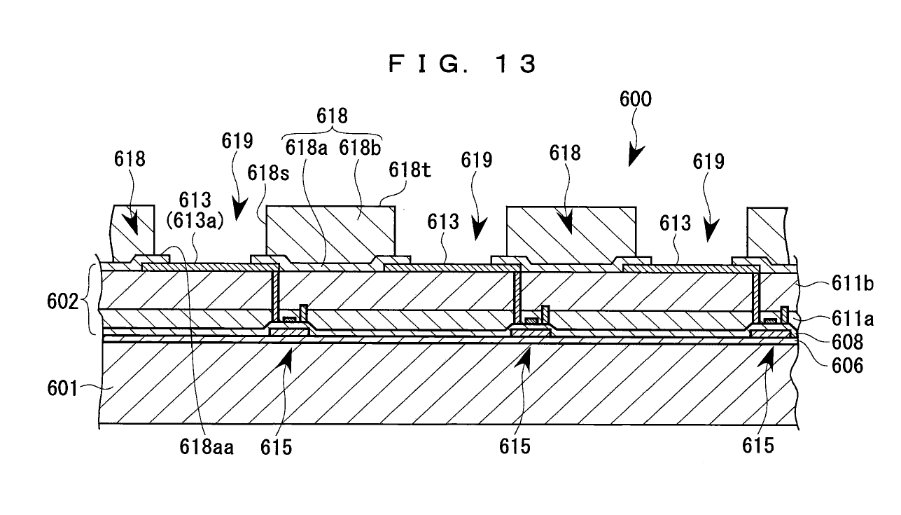

After the inorganic bank layers 618a are formed, as shown in FIG. 13, the organic bank layers 618b are formed on the inorganic bank layers 618a. As with the inorganic bank layers 618a, the organic bank layers 618b are formed by patterning a formed organic film by the photolithography technique.

The bank portions 618 are thus formed. When the bank portions 618 are formed, the openings 619 opening upward relative to the pixel electrodes 613 are formed between the bank portions 618. The openings 619 define pixel areas.

In the surface processing step (S112), a hydrophilic treatment and a repellency treatment are performed. The hydrophilic treatment is performed on first lamination areas 618aa of the inorganic bank layers 618a and electrode surfaces 613a of the pixel electrodes 613. The hydrophilic treatment is performed, for example, by plasma processing using oxide as a processing gas on surfaces of the first lamination areas 618aa and the electrode surfaces 613a to have hydrophilic properties. By performing the plasma processing, the ITO forming the pixel electrodes 613 is cleaned.

The repellency treatment is performed on walls 618s of the organic bank layers 618b and upper surfaces 618t of the organic bank layers 618b. The repellency treatment is performed as a fluorination treatment, for example, by plasma processing using tetrafluoromethane as a processing gas on the walls 618s and the upper surfaces 618t.

By performing this surface processing step, when the functional layers 617 is formed using the functional liquid droplet ejection heads 17, the functional liquid droplets are ejected onto the pixel areas with high accuracy. Furthermore, the functional liquid droplets attached onto the pixel areas are prevented from flowing out of the openings 619.

A display apparatus body 600A is obtained through these steps. The display apparatus body 600A is mounted on the set table 21 of the liquid droplet ejection apparatus 1 shown in FIG. 1 and the positive-hole injection/transport layer forming step (S113) and the light-emitting layer forming step (S114) are performed thereon.

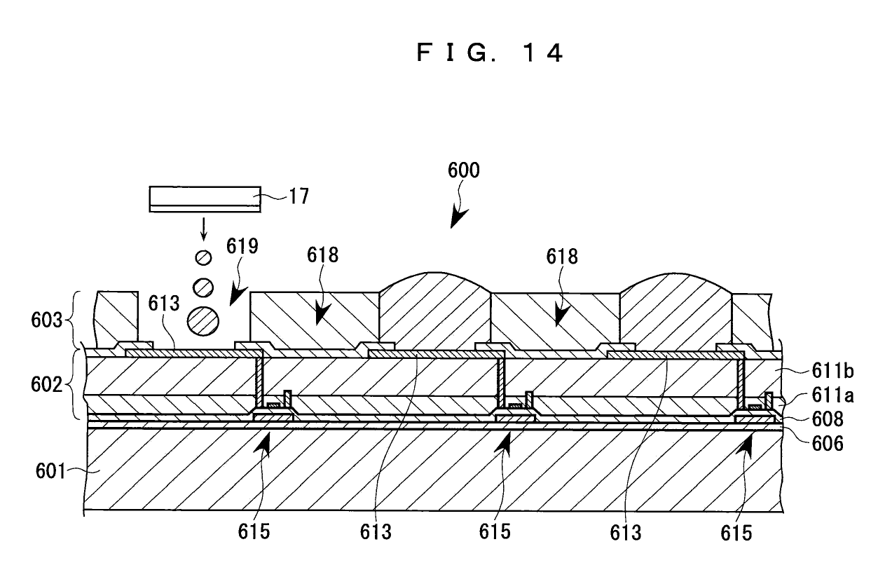

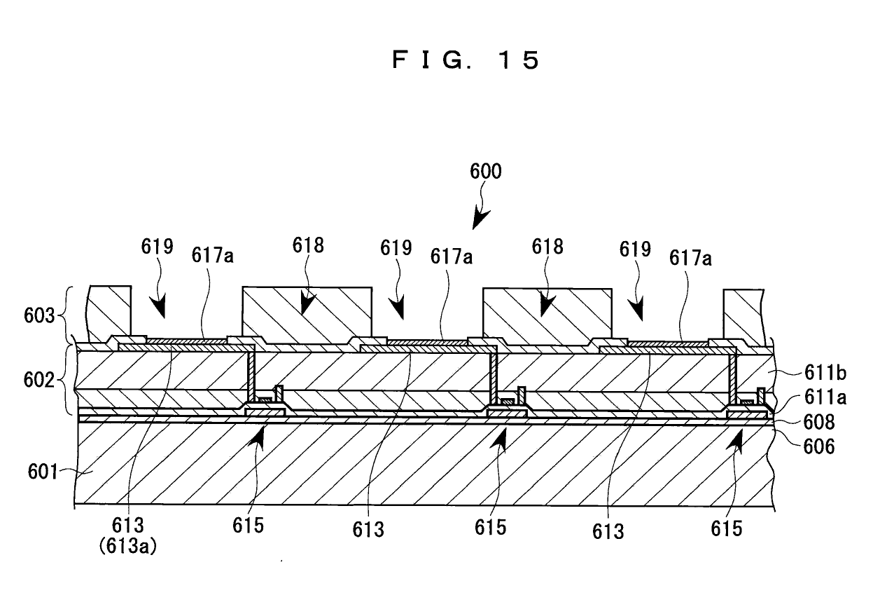

As shown in FIG. 14, in the positive-hole injection/transport layer forming step (S113), the first compositions including the material for forming a positive-hole injection/transport layer are ejected from the functional liquid droplet ejection heads 17 into the openings 619 included in the pixel areas. Thereafter, as shown in FIG. 15, drying processing and a thermal treatment are performed to evaporate polar solution included in the first composition whereby the positive-hole injection/transport layers 617a are formed on the pixel electrodes 613 (electrode surface 613a).

The light-emitting layer forming step (S114) will now be described. In the light-emitting layer forming step, as described above, a nonpolar solvent which is insoluble to the positive-hole injection/transport layers 617a is used as the solvent of the second composition used at the time of forming the light-emitting layer in order to prevent the positive-hole injection/transport layers 617a from being dissolved again.

On the other hand, since each of the positive-hole injection/transport layers 617a has low affinity to a nonpolar solvent, even when the second composition including the nonpolar solvent is ejected onto the positive-hole injection/transport layers 617a, the positive-hole injection/transport layers 617a may not be brought into tight contact with the light-emitting layers 617b or the light-emitting layers 617b may not be uniformly applied.

Accordingly, before the light-emitting layers 617b are formed, surface processing (surface improvement processing) is preferably performed so that each of the positive-hole injection/transport layers 617a has high affinity to the nonpolar solvent and to the material for forming the light-emitting layers. The surface processing is performed by applying a solvent the same as or similar to the nonpolar solvent of the second composition used at the time of forming the light-emitting layers on the positive-hole injection/transport layers 617a and by drying the applied solvent.

Employment of this surface processing allows the surface of the positive-hole injection/transport layers 617a to have high affinity to the nonpolar solvent, and therefore, the second composition including the material for forming the light-emitting layers can be uniformly applied to the positive-hole injection/transport layers 617a in the subsequent step.

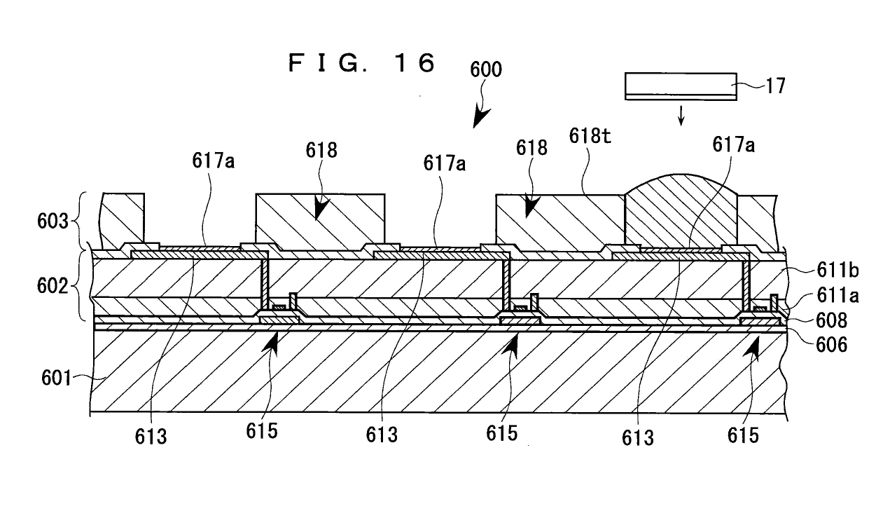

As shown in FIG. 16, a predetermined amount of second composition including the material for forming the light-emission layers of one of the three colors (blue color (B) in an example of FIG. 16) is ejected into the pixel areas (openings 619) as functional liquid. The second composition ejected into the pixel areas spreads over the positive-hole injection/transport layer 617a and fills the openings 619. Note that, even if the second composition is ejected and attached to the upper surfaces 618t of the bank portions 618 which are outside of the pixel area, since the repellency treatment has been performed on the upper surfaces 618t as described above, the second component easily drops into the openings 619.

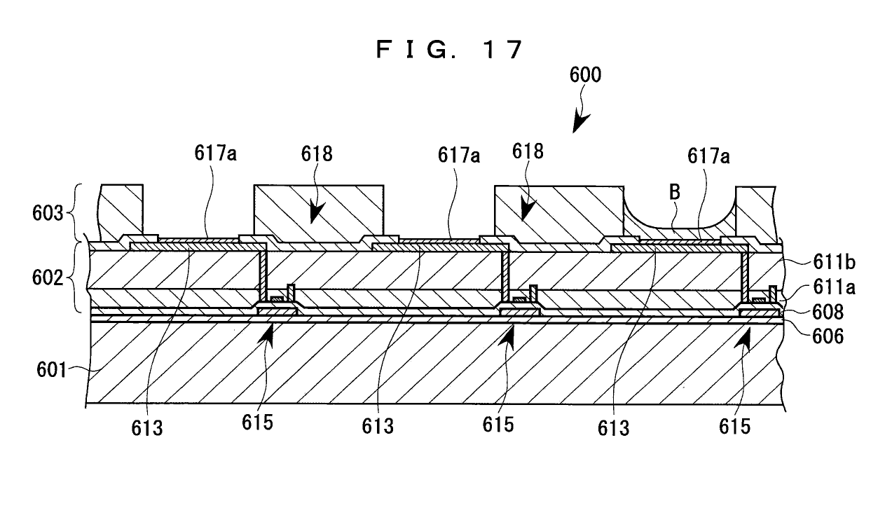

Thereafter, the drying processing is performed so that the ejected second composition is dried and the nonpolar solvent included in the second composition is evaporated whereby the light-emitting layers 617b are formed on the positive-hole injection/transport layers 617a as shown in FIG. 17. In FIG. 17, one of the light-emitting layers 617b corresponding to the blue color (B) is formed.

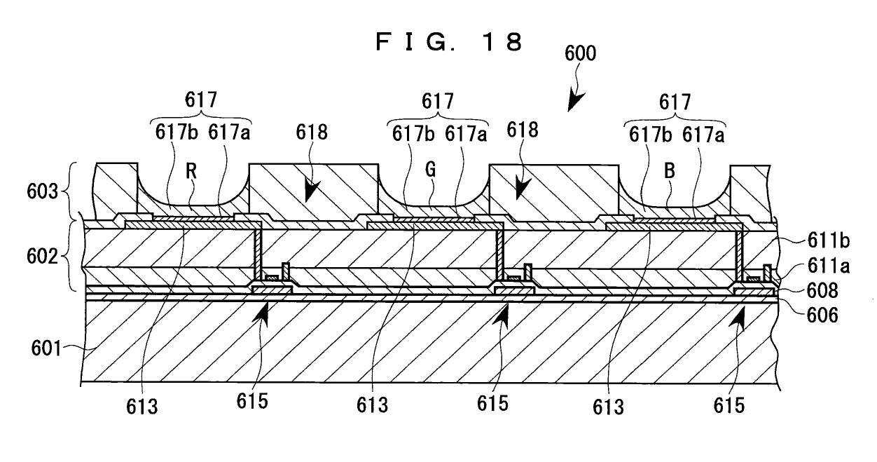

Similarly, as shown in FIG. 18, a step similar to the above-described step of forming the light-emitting layers 617b corresponding to the blue color (B) is repeatedly performed by using functional liquid droplet ejection heads 17 so that the light-emitting layers 617b corresponding to other colors (red (R) and green (G)) are formed. Note that the order of formation of the light-emitting layers 617b is not limited to the order described above as an example, and any other orders may be applicable. For example, an order of forming the light-emitting layers 617b may be determined in accordance with a light-emitting layer forming material. Furthermore, the color scheme pattern of the three colors R, G, and B may be the stripe arrangement, the mosaic arrangement, or the delta arrangement.

As described above, the functional layers 617, that is, the positive-hole injection/transport layers 617a and the light-emitting layers 617b are formed on the pixel electrodes 613. Then, the process proceeds to the counter electrode forming step (S115).

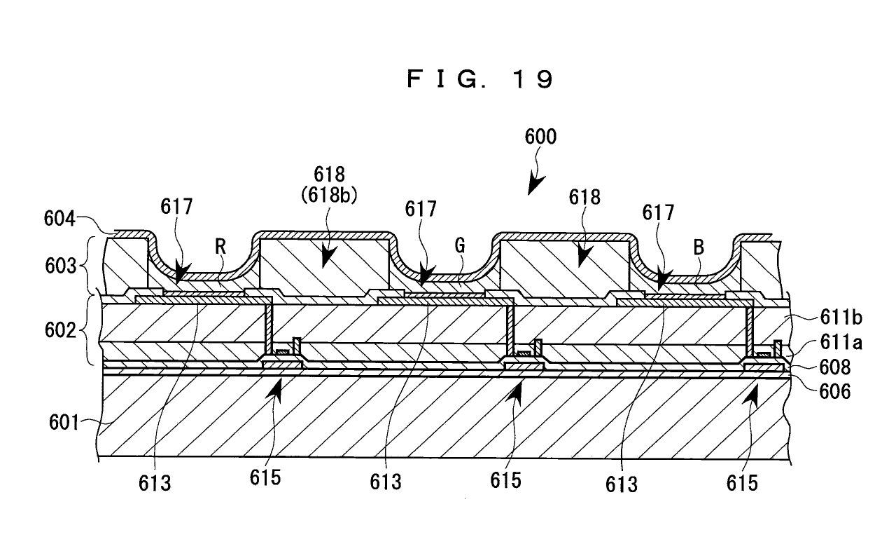

In the counter electrode forming step (S115), as shown in FIG. 19, the cathode (counter electrode) 604 is formed on entire surfaces of the light-emitting layers 617b and the organic bank layers 618b by an evaporation method, sputtering, or a CVD (chemical vapor deposition) method, for example. The cathode 604 is formed by laminating a calcium layer and an aluminum layer, for example, in this embodiment.

An Al film and a Ag film as electrodes and a protective layer formed of SiO₂ or SiN for preventing the Al film and the Ag film from being oxidized are formed on the cathode 604.

After the cathode 604 is thus formed, other processes such as sealing processing of sealing a top surface of the cathode 604 with a sealing member and wiring processing are performed whereby the display apparatus 600 is obtained.

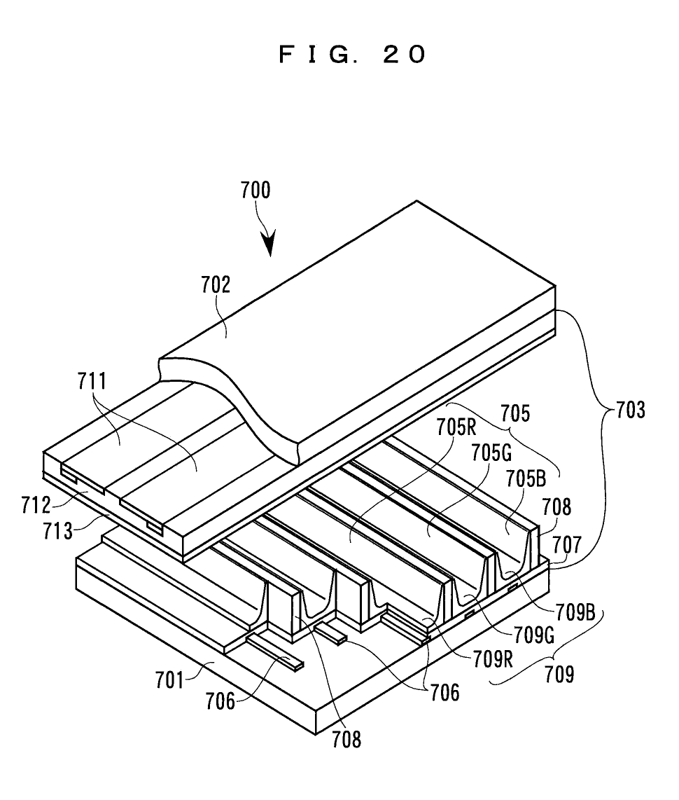

FIG. 20 is an exploded perspective view of an essential part of a plasma display apparatus (PDP apparatus: hereinafter simply referred to as a display apparatus 700). Note that, in FIG. 20, the display apparatus 700 is partly cut away.

The display apparatus 700 includes a first substrate 701, a second substrate 702 which faces the first substrate 701, and a discharge display portion 703 interposed therebetween. The discharge display portion 703 includes a plurality of discharge chambers 705. The discharge chambers 705 include red discharge chambers 705R, green discharge chambers 705G, and blue discharge chambers 705B, and are arranged so that one of the red discharge chambers 705R, one of the green discharge chambers 705G, and one of the blue discharge chambers 705B constitute one pixel as a group.

Address electrodes 706 are arranged on the first substrate 701 with predetermined intervals therebetween in a stripe pattern, and a dielectric layer 707 is formed so as to cover top surfaces of the address electrodes 706 and the first substrate 701. Partition walls 708 are arranged on the dielectric layer 707 so as to be arranged along with the address electrodes 706 in a standing manner between the adjacent address electrodes 706. Some of the partition walls 708 extend in a width direction of the address electrodes 706 as shown in FIG. 20, and the others (not shown) extend perpendicular to the address electrodes 706.

Regions partitioned by the partition walls 708 serve as the discharge chambers 705.

The discharge chambers 705 include respective fluorescent substances 709. Each of the fluorescent substances 709 emits light having one of the colors of red (R), green (G) and blue (B). The red discharge chamber 705R has a red fluorescent substance 709R on its bottom surface, the green discharge chamber 705G has a green fluorescent substance 709G on its bottom surface, and the blue discharge chamber 705B has a blue fluorescent substance 709B on its bottom surface.

On a lower surface of the second substrate 702 in FIG. 20, a plurality of display electrodes 711 are formed with predetermined intervals therebetween in a stripe manner in a direction perpendicular to the address electrodes 706. A dielectric layer 712 and a protective film 713 formed of MgO, for example, are formed so as to cover the display electrodes 711.

The first substrate 701 and the second substrate 702 are attached so that the address electrodes 706 are arranged perpendicular to the display electrodes 711. Note that the address electrodes 706 and the display electrodes 711 are connected to an alternate power source (not shown).

When the address electrodes 706 and the display electrodes 711 are brought into conduction states, the fluorescent substances 709 are excited and emit light whereby display with colors is achieved.

In this embodiment, the address electrodes 706, the display electrodes 711, and the fluorescent substances 709 may be formed using the liquid droplet ejection apparatus 1 shown in FIG. 1. Steps of forming the address electrodes 706 on the first substrate 701 are described hereinafter.

The steps are performed in a state where the first substrate 701 is mounted on the set table 21 on the liquid droplet ejection apparatus 1.

The functional liquid droplet ejection heads 17 eject a liquid material (functional liquid) including a material for forming a conducting film wiring as functional droplets to be attached onto regions for forming the address electrodes 706. The material for forming a conducting film wiring included in the liquid material is formed by dispersing conductive fine particles such as those of a metal into dispersed media. Examples of the conductive fine particles include a metal fine particle including gold, silver, copper, palladium, or nickel, and a conductive polymer.

When ejection of the liquid material onto all the desired regions for forming the address electrodes 706 is completed, the ejected liquid material is dried, and the disperse media included in the liquid material is evaporated whereby the address electrodes 706 are formed.

Although the steps of forming the address electrodes 706 are described as an example above, the display electrodes 711 and the fluorescent substances 709 may be formed by the steps described above.

In a case where the display electrodes 711 are formed, as with the address electrodes 706, a liquid material (functional liquid) including a material for forming a conducting film wiring is ejected from the functional liquid droplet ejection heads 17 as liquid droplets to be attached to the areas for forming the display electrodes.

In a case where the fluorescent substances 709 are formed, a liquid material including fluorescent materials corresponding to three colors (R, G, and B) is ejected as liquid droplets from the functional liquid droplet ejection heads 17 so that liquid droplets having the three colors (R, G, and B) are attached within the discharge chambers 705.

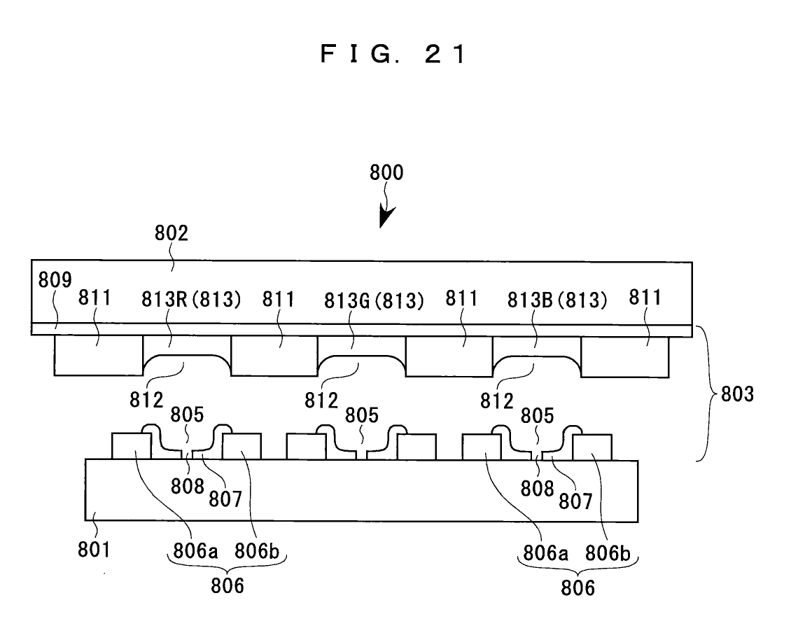

FIG. 21 shows a sectional view of an essential part of an electron emission apparatus (also referred to as a FED apparatus or a SED apparatus: hereinafter simply referred to as a display apparatus 800). In FIG. 21, a part of the display apparatus 800 is shown in the sectional view.

The display apparatus 800 includes a first substrate 801, a second substrate 802 which faces the first substrate 801, and a field-emission display portion 803 interposed therebetween. The field-emission display portion 803 includes a plurality of electron emission portions 805 arranged in a matrix.

First element electrodes 806a and second element electrodes 806b, and conductive films 807 are arranged on the first substrate 801. The first element electrodes 806a and the second element electrodes 806b intersect with each other. Cathode electrodes 806 are formed on the first substrate 801, and each of the cathode electrodes 806 is constituted by one of the first element electrodes 806a and one of the second element electrodes 806b. In each of the cathode electrodes 806, one of the conductive films 807 having a gap 808 is formed in a portion formed by the first element electrode 806a and the second element electrode 806b. That is, the first element electrodes 806a, the second element electrodes 806b, and the conductive films 807 constitute the plurality of electron emission portions 805. Each of the conductive films 807 is constituted by palladium oxide (PdO). In each of the cathode electrodes 806, the gap 808 is formed by forming processing after the corresponding one of the conductive films 807 is formed.

An anode electrode 809 is formed on a lower surface of the second substrate 802 so as to face the cathode electrodes 806. A bank portion 811 is formed on a lower surface of the anode electrode 809 in a lattice. Fluorescent materials 813 are arranged in opening portions 812 which opens downward and which are surrounded by the bank portion 811. The fluorescent materials 813 correspond to the electron emission portions 805. Each of the fluorescent materials 813 emits fluorescent light having one of the three colors, red (R), green (G), and blue (B). Red fluorescent materials 813R, green fluorescent materials 813G, and blue fluorescent materials 813B are arranged in the opening portions 812 in a predetermined arrangement pattern described above.

The first substrate 801 and the second substrate 802 thus configured are attached with each other with a small gap therebetween. In this display apparatus 800, electrons emitted from the first element electrodes 806a or the second element electrodes 806b included in the cathode electrodes 806 hit the fluorescent materials 813 formed on the anode electrode 809 so that the fluorescent materials 813 are excited and emit light whereby display with colors is achieved.

As with the other embodiments, in this case also, the first element electrodes 806a, the second element electrodes 806b, the conductive films 807, and the anode electrode 809 may be formed using the liquid droplet ejection apparatus 1. In addition, the red fluorescent materials 813R, the green fluorescent materials 813G, and the blue fluorescent materials 813B may be formed using the liquid droplet ejection apparatus 1.

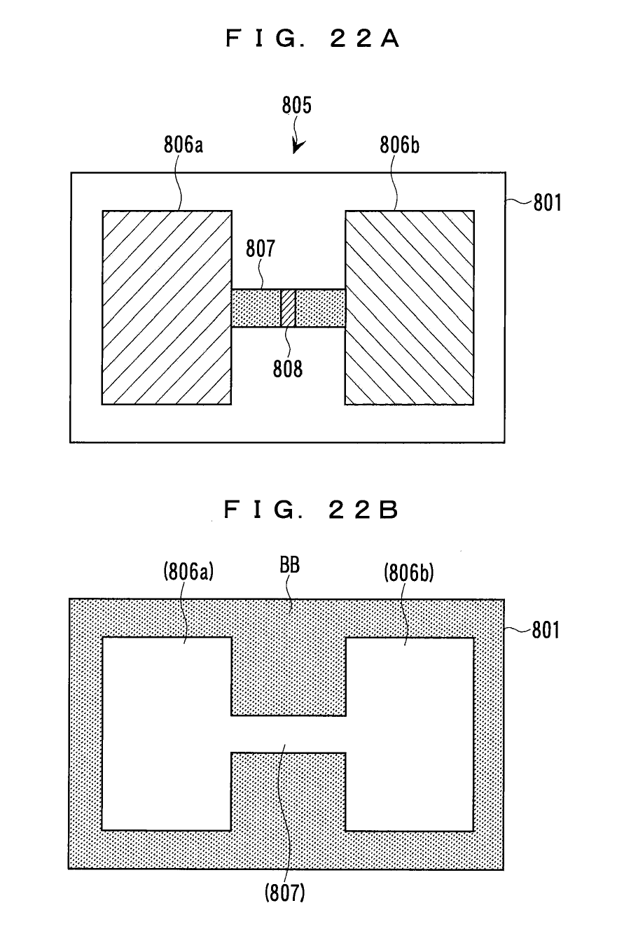

Each of the first element electrodes 806a, each of the second element electrodes 806b, and each of the conductive films 807 have shapes as shown in FIG. 22A. When the first element electrodes 806a, the second element electrodes 806b, and the conductive films 807 are formed, portions for forming the first element electrodes 806a, the second element electrodes 806b, and the conductive films 807 are left as they are on the first substrate 801 and only bank portions BB are formed (by a photolithography method) as shown in FIG. 22B. Then, the first element electrodes 806a and the second element electrodes 806b are formed by an inkjet method using a solvent ejected from the liquid droplet ejection apparatus 1 in grooves defined by the bank portions BB and are formed by drying the solvent. Thereafter, the conductive films 807 are formed by the inkjet method using the liquid droplet ejection apparatus 1. After forming the conductive films 807, the bank portions BB are removed by ashing processing and the forming processing is performed. Note that, as with the case of the organic EL device, the hydrophilic treatment is preferably performed on the first substrate 801 and the second substrate 802 and the repellency treatment is preferably performed on the bank portion 811 and the bank portions BB.

Examples of other electro-optical apparatuses include an apparatus for forming metal wiring, an apparatus for forming a lens, an apparatus for forming a resist, and an apparatus for forming an optical diffusion body. Use of the liquid droplet ejection apparatus 1 makes it possible to efficiently manufacture various electro-optical apparatuses.

What is claimed is:

1. A method for filling a functional liquid droplet ejection head with functional liquid, comprising:
initially filling functional liquid channels and intrahead channels included in the functional liquid droplet ejection head with a functional liquid by introducing functional liquid from a functional liquid tank through the functional liquid channels to the functional liquid droplet ejection head used in an inkjet mode; and
passing cleaning liquid into the functional liquid channels and the intrahead channel included in the functional liquid droplet ejection head prior to the initially filling.

2. The method for filling a functional liquid droplet ejection head with functional liquid according to claim 1, wherein
a solvent of the functional liquid is used as the cleaning liquid in the passing cleaning liquid.

3. The method for filling a functional liquid droplet ejection head with functional liquid according to claim 1, wherein
a solution containing a surfactant is used as the cleaning liquid in the passing cleaning liquid.

4. The method for filling a functional liquid droplet ejection head with functional liquid according to claim 1, wherein
a solution containing the solvent of the functional liquid and a surfactant is used as the cleaning liquid and the solution is passed after the solvent is passed in the passing cleaning liquid.

5. The method for filling a functional liquid droplet ejection head with functional liquid according to claim 1, wherein
a solution containing the solvent of the functional liquid and a surfactant is used as the cleaning liquid, the solution is passed after the solvent is passed, and the solvent is passed again in the passing cleaning liquid.

6. The method for filling a functional liquid droplet ejection head with functional liquid according to claim 1, wherein
initial filling is performed through suction of functional liquid from ejection nozzles on the functional liquid droplet ejection head with the functional liquid channels connected to the functional liquid tank in the initially filling and liquid passage is performed through suction of cleaning liquid from the ejection nozzles on the functional liquid droplet ejection head with the functional liquid channels switched to be connected to a cleaning liquid tank from the functional liquid tank in the passing cleaning liquid.

7. A functional liquid supplying device, comprising:
a functional liquid tank that supplies functional liquid to a functional liquid droplet ejection head used in an inkjet mode;
cleaning liquid tanks that supply cleaning liquid to the functional liquid droplet ejection head;
functional liquid channels that connect the functional liquid tank and one of the cleaning liquid tanks with the functional liquid droplet ejection head;
a channel switching unit that makes the functional liquid channels fluidicly switch to be connected to the functional liquid tank or one of the cleaning liquid tanks at their upstream end;
a suction unit that sucks up the functional liquid and the cleaning liquid individually, closely and detachably attached to a nozzle face of the functional liquid droplet ejection head; and
a control unit that controls the channel switching unit and the suction unit,
wherein the control unit performs a cleaning liquid passage operation of making the functional liquid channels switch to be connected to one of the cleaning liquid tanks and driving the suction unit to pass cleaning liquid into the functional liquid channels and an intrahead channel included in the functional liquid droplet ejection head prior to an initial filling operation of making the functional liquid channels switch to be connected to the functional liquid tank and driving the suction unit to fill the functional liquid channels and the intrahead channel included in the functional liquid droplet ejection head with functional liquid.

8. The functional liquid supplying device according to claim 7, wherein
the cleaning liquid is any one of solutions containing a solvent of the functional liquid and a surfactant.

9. The functional liquid supplying device according to claim 7, wherein
the cleaning liquid is a solution containing the solvent of the functional liquid and a surfactant, the cleaning liquid tanks are formed of a solvent tank storing the solvent and a solution tank storing the solution, the channel switching unit is configured so as to be capable of switching channels for each of the functional liquid tank, the solvent tank and the solution tank, and the control unit, in a cleaning liquid passage operation, first performs a solvent passage operation of making the functional liquid channels switch to be connected to the solvent tank and driving the suction unit to pass the solvent into the functional liquid channels and an intrahead channel included in the functional liquid droplet ejection head and next performs a solution passage operation of making the functional liquid channels switch to be connected to the solution tank and driving the suction unit to pass the solvent into the functional liquid channels and the intrahead channel included in the functional liquid droplet ejection head.

10. The functional liquid supplying device according to claim 7, wherein
the cleaning liquid is the solvent of the functional liquid and a solution containing a surfactant, the cleaning liquid tanks are formed of a solvent tank storing the solvent and a solution tank storing the solution, the channel switching unit is configured so as to be capable of switching channels from the functional liquid tank, the solvent tank and the solution tank, and the control unit, in a cleaning liquid passage operation, first performs a solvent passage operation of making the functional liquid channels switch to be connected to the solvent tank and driving the suction unit to pass the solvent into the functional liquid channels and an intrahead channel included in the functional liquid droplet ejection head, next performs a solution passage operation of making the functional liquid channels switch to be connected to the solution tank and driving the suction unit to pass the solvent into the functional liquid channels and the intrahead channel included in the functional liquid droplet ejection head, and again performs the solvent passage operation.

11. A liquid droplet ejection apparatus, comprising:
a functional liquid supplying device according to claim 7; and
a plotting device that ejects functional liquid droplets while moving the functional liquid droplet ejection head relatively to a workpiece.

12. A method for manufacturing an electro-optical apparatus that forms a film of functional liquid droplets on the workpiece by using the liquid droplet ejection apparatus set forth in claim 11.

13. An electro-optical apparatus that forms a film of functional liquid droplets provided by the liquid droplet ejection apparatus set forth in claim 11 on the workpiece.
